(19) United States
(12) Patent Application Publication
(10) Pub. No.: US 2011/0121632 A1
(43) Pub. Date: May 26, 2011

(54) FITTING FOR HANGING A CHAIR, AND CHAIR HAVING SUCH A FITTING

(76) Inventor: Anders LINDBOM, Taberg (SE)

(21) Appl. No.: 12/951,234

(22) Filed: Nov. 22, 2010

(30) Foreign Application Priority Data
Nov. 23, 2009 (SE) 0950887-0

(51) Int. Cl. A47C 31/00; F16M 13/02

(52) U.S. Cl. 297/463.1; 248/220.21

(57) ABSTRACT

The present invention relates to a fitting (1) for mounting on a chair (20) for the purpose of hanging the chair on a table top (30), characterized in that the fitting (1) comprises a holder (6), designed to be secured to a seat (21), and a yoke (2) coupled to the holder (6), said yoke (2) being movable relative to the holder (6), said yoke (2) being able to be shifted between a first position and a second position when it is mounted on the chair (20), and said yoke (2), in the first position, extending below the seat (21) of the chair in a vertical direction, and, in the second position, extending above the seat (21) of the chair in the vertical direction, when the chair (20) is upright.

The invention further relates to a chair (20) with two such fittings (1) mounted on the chair (20).

### TECHNICAL FIELD

The present invention relates to a fitting for hanging a chair on the edge of a table or another piece of furniture.

### BACKGROUND OF THE INVENTION

When cleaning floors in premises in which there are chairs and tables, it is usually necessary to lift or move the chairs in order to gain access to the surface under the table. If the chairs are provided with armrests, the latter can be used to hang the chair on the table edge. However, the height difference between the armrests and the table top when the chair is standing on the floor is often not particularly great, which means that the chair, when it is hung by the armrests on the table edge, is hanging less than ten centimeters above the floor surface. This means that cleaning the floor surface under the table, for example with a mop, is still extremely difficult, because the chair is hanging in the way.

For chairs without armrests, an alternative way of solving the problem of the chair not being far enough from the floor surface is to lift the chair up, turn it upside down and place it on the table top, with the seat part of the chair facing the table. This involves high and strenuous lifting, especially when cleaning large premises in which there are a large number of chairs.

There is therefore a need for a solution which makes it possible to move a chair out of the way in order to gain access for cleaning under the table, without involving high and strenuous lifting of the chair.

### DISCLOSURE OF THE INVENTION

At least one of the above problems is solved with the aid of a fitting according to claim 1.

Embodiments of the invention will become clear from the independent claims and from the following description and drawings.

According to a first aspect of the invention, a fitting is obtained for mounting on a chair for the purpose of hanging the chair on a table top, characterized in that the fitting comprises a holder, designed to be secured to a seat of a chair, and a yoke coupled to the holder, said yoke being movable relative to the holder, said yoke being able to be shifted between a first position and a second position when it is mounted on the chair, and said yoke, in the first position, extending below the seat of the chair in a vertical direction, and, in the second position, extending above the seat of the chair in the vertical direction, when the chair is upright.

By designing a fitting in this way, such a fitting can be used by being secured to a chair such that the chair is moved aside during cleaning, etc. Two fittings are preferably secured to the chair, preferably at opposite side edges of the chair. In this way, the chair can be hung on a table top. The fitting can be secured such that the holder is secured to the seat of the chair and the yoke extends directly across the seat of the chair. This can have the effect that the chair, when hung on the table, comes to a height such that the seat is located directly under the table top. When the chair comes up so high, this creates a lot of space for cleaning the floor surface under the table. The yoke can extend above the seat in the vertical direction such that the vertical distance between the yoke and the seat is at least the same length as the thickness of a table top. In this way, the yoke can bear on the upper face of the table top, and the seat can be located under the table top. An advantage of the invention is also that the fitting can be secured to a chair without armrests. Such a chair can then be hung on a table without the need for strenuous lifting and turning of the chair. Moreover, the two positions of the yoke mean that, in the first position, it can be retracted below the seat of the chair so as not to be in the way.

When the yoke is described as extending in a vertical direction, this means a direction at right angles to the substantially horizontal plane in which the seat of the chair lies when the chair is in the upright position. The yoke extends further along the vertical direction toward one or other end in the two positions than the position along the vertical direction where the horizontal plane of the seat is substantially located.

In one embodiment, the holder can be designed to be secured to the underside of a seat. This means that the fitting can be mounted on a chair without interfering with the appearance of the chair and without affecting the seating comfort. When the yoke is located in the second position, it extends out from the holder on the underside of the seat, outside and above the seat.

In a further embodiment, the yoke, in the first position, can extend toward the underside of the seat. In this way, the yoke, in the first position, is not only able to be lowered so as not to get in the way of someone sitting on the chair, it can also be turned in under the seat so as not to be visible. The fact that the yoke can extend toward the underside of the seat means that the yoke can extend from the point of attachment of the holder on the chair toward an area of the underside of the seat alongside the point of attachment. The yoke can extend in a direction that is substantially parallel to the plane in which the seat lies, but it can also be at a slight angle to the seat, for example such that the yoke bears against the underside of the seat.

In one embodiment, the fitting can further comprise a spring, wherein the spring can be arranged to hold the yoke in the first and/or second position by means of a spring force. The effect achieved by this is that the yoke can be sprung toward the first or second position when the yoke is driven from one position to the other. This also means that the yoke is held steadily in a given position.

In one embodiment, the holder can be coupled to the spring and to a first part of the yoke. In a further embodiment, the holder can extend along a longitudinal axis, and the yoke can be rotatable relative to the holder around the longitudinal axis. In this way, the yoke is made movable relative to the chair, since the holder is secured to the chair. The holder can extend along a longitudinal axis, and the first part of the yoke can be coupled to the holder such that when the yoke moves relative to the holder, the first part of the yoke turns around the longitudinal axis. A second part of the yoke can extend away from the longitudinal axis. In this way, the second part of the yoke moves between the two positions when the first part of the yoke is turned around the longitudinal axis. The second part of the yoke can then extend away from the longitudinal axis, inward under the seat surface, when the first part of the yoke has been turned such that the yoke is located in the first position, and, moreover, the second part of the yoke can extend away from the longitudinal axis, outward and upward from the seat, when the first part of the yoke has been turned such that the yoke is located in the second position.

In a further embodiment, the holder can be designed to control the movement of the yoke between the first and second positions of the yoke, such that the spring, in an intermediate position between the first and second positions of the yoke, exerts a greater spring force on the yoke than in the first or second position, and wherein the yoke passes through said intermediate position when it is shifted between the first and second positions. The intermediate position makes it necessary for a user to apply force to the yoke in order to shift the yoke from one position to the other. Since the spring force is greater between the first and second positions, that is to say at the intermediate position, the yoke is not able to move spontaneously, without application of external force, from either of said first and second positions.

In one embodiment, the holder can also extend along a longitudinal axis, and one end of the holder along the longitudinal axis can have a beveled surface, such that one side of the holder has a longer extent along the longitudinal axis than does the other side of the holder.

Moreover, in one embodiment, a section of the yoke can bear against the beveled end of the holder, and said section can bear against said side of the holder with the shortest extent along the longitudinal axis when the yoke is located in said first position.

In this way, the spring force on the yoke is controlled by the shape of the holder when the yoke is shifted between the first and second positions. Since the spring holds the yoke in, the yoke cannot spontaneously move around the end of the holder and thus past the intermediate position where the extent of the holder is longer and the spring force on the yoke is greater, when it is located in the first or second position.

In one embodiment, the holder can extend along a longitudinal axis, and the yoke can have a first part secured in the holder and a second part extending substantially parallel to the longitudinal axis, and wherein the second part is located at a distance from the longitudinal axis. In this way, when the holder is mounted on a chair, and the yoke is located in its second position, the second part of the yoke can extend out parallel to the longitudinal axis through the holder, but above the seat in the vertical direction. The second part of the yoke can then be hung on a table top such that the seat hangs under and substantially parallel to the table top.

In a further embodiment, the second part of the yoke can be located at a distance of 5-12 cm, preferably 5-10 cm, and more preferably 6-9 cm, from the longitudinal axis. The seat then hangs near the underside of the table top when the second part of the yoke bears against the upper face of the table top. The distance can be adjusted depending on the thickness of the table top and the thickness of the seat.

According to a second aspect of the invention, a chair is obtained for hanging on a table, said chair comprising two fittings according to the invention, the fittings being arranged at opposite side edges of the chair. In this way, the two fittings can both be deployed to the second position where the yoke extends above the seat of the chair in the vertical direction such that they can be hung on the table top. The chair is then located high up from the floor surface and facilitates cleaning under the table and chair.

In a further embodiment, both fittings are secured to the underside of the seat. In this way, the fittings are not in the way and do not affect the appearance of the chair. When the yokes are shifted to their first position, they are substantially concealed beneath the seat of the chair.

### BRIEF DESCRIPTION OF THE DRAWINGS

FIG. 1a shows an exploded perspective view of a fitting according to one embodiment of the invention.

FIG. 1b shows a top view of a fitting according to one embodiment of the invention.

FIG. 1c shows a top view of a fitting according to one embodiment of the invention.

FIG. 2a shows a perspective view of a fitting according to one embodiment of the invention mounted on a chair.

FIG. 2b shows a perspective view of a fitting according to one embodiment of the invention mounted on a chair hung on a table.

### DESCRIPTION OF PREFERRED EMBODIMENTS

The present invention is described in more detail below with reference to the accompanying drawings in which preferred embodiments of the invention are shown. However, the invention can be implemented in many different forms and must not be interpreted as being limited to the embodiments presented here. Rather, these embodiments are intended to ensure that the present description is clear and comprehensive and fully conveys the scope of the invention to a person skilled in the art. In the drawings, the same numbers refer to the same elements.

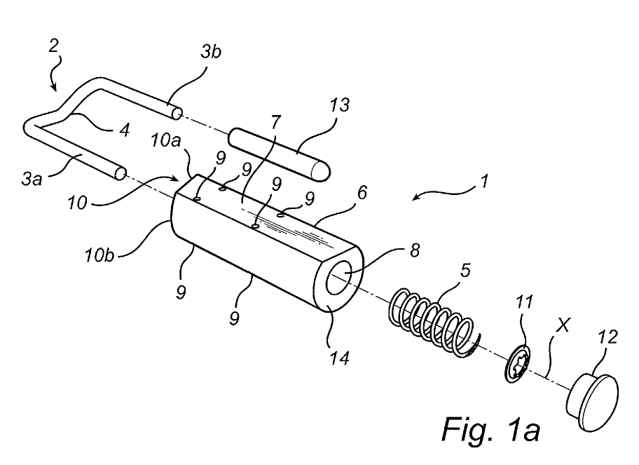

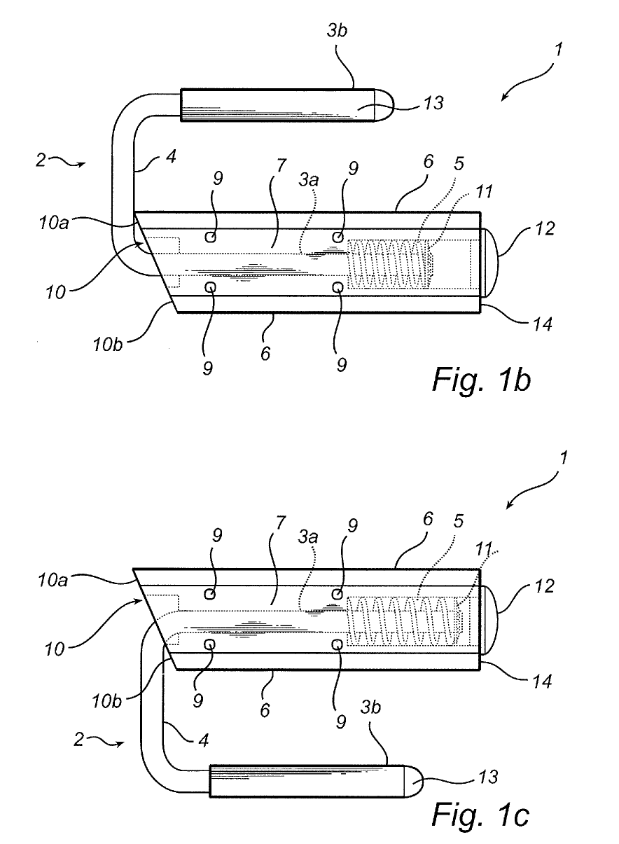

FIGS. 1a, 1b and 1c show a fitting 1 according to the invention with a yoke 2 which has a U-shape with a first part 3a, a second part 3b and a middle part 4. The first part 3a and second part 3b of the yoke are substantially parallel and are separated by the middle part 4. Substantially right angles form between the middle part 4 and the first 3a and second 3b parts, respectively. The middle part 4 is slightly bent along the extent between the first 3a and second 3b parts. In this way, the middle part 4 has a first part connected to the first part 3a of the yoke and a second part connected to the second part 3b of the yoke. The two parts of the middle part are separated by the bend.

The first part 3a of the yoke is coupled to a spring 5 and a holder 6. The holder 6, the spring 5 and the first part 3a of the yoke extend along a common longitudinal axis X. The holder 6 is tubular with a through-opening 8 for receiving the spring 5 and the first part 3a of the yoke. At the end of the first part 3a of the yoke located farthest from the middle part, a locking washer 11 is secured to the yoke. The spring 5 bears with one end against the locking washer 11. The spring 5 presses the part 3a of the yoke into the holder 6 via the locking washer 11. This means that the yoke 2 is maintained in a certain position when the fitting 1 is mounted on a chair. The first part 3a of the yoke extends through almost the whole length of the holder and through the whole spring 5, along the longitudinal axis X. At its other end, the spring 5 bears against a narrowed part of the through-opening 8, integrally formed inside the holder 6.

One end 10 of the holder, the end that receives the yoke 2, is beveled. This end 10 is therefore not at right angles to the longitudinal axis X in the way that the other end 14 of the holder is. One side 10a of the end 10 thus extends farther along the longitudinal axis X than the other side 10b of the end 10. When the spring 5 presses the yoke 2 into the holder 6 via the locking washer 11, the middle part 4 of the yoke bears against the end 10 of the holder. When the yoke 2 is shifted between the first position and the second position, the middle part 4 of the yoke turns along the end 10 of the holder such that, in an intermediate position, it passes across the longer side 10a of the end 10 of the holder (see FIG. 1b). In the intermediate position, the first part 3a of the yoke is drawn out of the holder such that the locking washer 11 presses against the spring 5 and the spring is compressed. Thus, in the intermediate position, the spring 5 applies a spring force to the locking washer 11 and to the first part 3a of the yoke that is greater than the spring force that the spring 5 applies in the first or second position of the yoke. The beveled end 10 of the holder thus has the effect that the yoke 2 can be maintained in the first or second position by the spring 5, and a certain external force needs to be applied by a user in order to turn the yoke 2 past the intermediate position and the longer side 10a of the end 10 of the holder. FIG. 1c shows a position of the yoke 2 where the middle part 4 of the yoke bears against the shorter side 10b of the end 10 of the holder. In this position, the spring 5 is in a more stretched-out state and thus presses on the locking washer 11 with a lesser spring force than in the intermediate position of the yoke.

Outside the locking washer 11, on the edge 14 of the holder, a cap 12 is fitted in order to protect the parts in the holder 6.

In order to mount the holder 6 on the underside of a chair, the outer and otherwise round surface of the holder is chamfered on one side to form a flat surface 7. This surface 7 is placed in contact with the underside of the seat, and the holder 6 is secured to the chair by screws engaging through screw holes 9.

To avoid the yoke 2 making marks on the table top, and to avoid the yoke 2 and chair sliding off the table top when the chair with the mounted fitting 1 is hung therefrom, the second part 3b of the yoke is provided with non-slip protection 13. The non-slip protection 13 is preferably made of a rubber or plastic material.

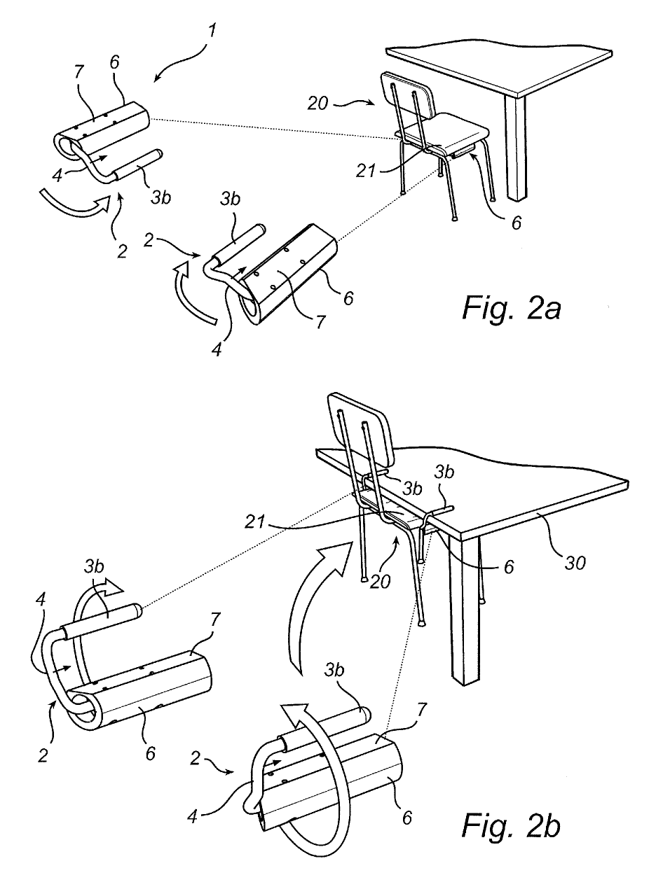

FIG. 2a describes two fittings 1 according to the invention, the fittings preferably being mounted at opposite side edges of a chair 20. The holders 6 of the fittings are screwed securely to the chair by means of screws engaging through the screw holes 9, with the flat surface 7 toward the underside of the seat 21. The yokes 2 are turned to their first position such that they are directed in under the seat 21. That is to say, in this position the second part 3b of the yokes is located under the seat (bearing against the underside of the seat). This means that only the holder 6 is visible when the fitting 1 is mounted on the chair 20. The yokes 2 are maintained in the first position by means of the spring drawing the yokes 2 into the holder 6 when the middle parts 4 of the yokes bear against the shorter side 10b of the holder 6.

In FIG. 2b, the yokes 2 are turned to the second position via the intermediate position. In the second position, the yokes 2 extend obliquely outward and upward from the underside of the seat. The yoke 2 is maintained in the second position by means of the spring drawing in the yoke 2. This has the effect that the middle part 4 of the yoke is held between the edge of the seat and the longer side 10a of the holder. Since the middle part 4 of the yoke 2 has a bend, the first part of the middle part 4 extends from the holder 6 and obliquely outward and upward. The second part of the middle part 4, being separated from the first part by the bend of the middle part 4, turns relative to the first part and extends substantially straight up in a vertical direction when the chair 20 is upright. The second part of the middle part 4 is connected to the second part 3b of the yoke 2.

This means that the second parts 3b of the yokes can be hung on a table top 30 such that the seat 21 hangs near the underside of the table top. The chair 20 thus hangs at just the right height above the floor surface to allow cleaning to be easily carried out under the table and the chair 20. The distance between the longitudinal axis X of the holder 6 and the second part 3b of the yoke is ca. 6-9 cm. The second part 3b is then located at least 5 cm from the outer edge of the holder 6, this being sufficiently far out and up, above the seat 21, to allow the table top 30 to be received in the space between the second part 3b of the yoke and the seat 21 in the vertical direction. When the yoke 2 is turned between the first and second positions around the longitudinal axis X, the distance between the holder 6 and the second part 3b of the yoke is substantially the same the entire time.

When the fitting 1 is mounted on the chair 20, it is mounted such that the side 10a of the holder with the longer extent along the longitudinal axis X is located nearest to the outer edge of the seat 21. This therefore guides the placement of the longer side 10a of the holder relative to the flat surface 7 of the holder. The flat surface 7 lies in a plane that is substantially parallel to a direction oriented out at right angles from the longer side 10a of the holder 6. This means that in the intermediate position of the yoke 2, when the middle part 4 of the yoke bears against the longer side 10a of the end 10 of the holder, the yoke 2 extends straight out to the side from the chair, in a direction substantially parallel to the horizontal plane formed by the seat 21 of the chair. When the yoke 2 is then shifted toward its second position, past the intermediate position, the spring 5 draws the yoke 2 into the holder 6, such that the yoke 2, when it has reached the second position, is maintained there by virtue of the fact that it bears against the end 10 of the holder and also against the edge of the seat 21 of the chair. In its first position, the yoke 2 has been moved past the intermediate position such that the spring force in the spring draws the yoke 2 in toward the underside of the seat 21 of the chair.

When two fittings are mounted on a chair 20, the two fittings are arranged in mirror symmetry to each other.

1. A fitting (1) for mounting on a chair (20) for the purpose of hanging the chair on a table top (30),
characterized in that the fitting comprises
a holder (6), designed to be secured to a seat (21) of the chair, and
a yoke (2) coupled to the holder,
said yoke being movable relative to the holder, said yoke being able to be shifted between a first position and a second position when it is mounted on the chair, and said yoke, in the first position, extending below the seat of the chair in a vertical direction, and, in the second position, extending above the seat of the chair in the vertical direction, when the chair is upright.

2. The fitting according to claim 1, wherein the holder (6) is designed to be secured to the underside of the seat (21).

3. The fitting according to claim 1 or 2, wherein the yoke (2), in the first position, extends toward the underside of the seat.

4. The fitting according to any one of the preceding claims, wherein the fitting further comprises a spring (5), the spring being arranged to hold the yoke (2) in the first and/or the second position by means of a spring force.

5. The fitting according to claim 4, wherein the holder (6) is coupled to the spring (5) and to a first part (3a) of the yoke.

6. The fitting according to any one of the preceding claims, wherein the holder (6) extends along a longitudinal axis (X), and the yoke (2) is rotatable relative to the holder about the longitudinal axis.

7. The fitting according to either one of claims 4-5, wherein the holder (6) is designed to control the movement of the yoke (2) between the first and the second positions of the yoke, such that the spring (5), in an intermediate position between the first and the second positions of the yoke, exerts a greater spring force on the yoke than in the first or the second position, and wherein the yoke passes through said intermediate position when it is shifted between the first and the second positions.

8. The fitting according to any one of the preceding claims, wherein the holder (6) extends along a longitudinal axis (X), and wherein one end (10) of the holder along the longitudinal axis has a beveled surface such that a first side (10a) of the holder has a longer extent along the longitudinal axis than does a second side (10b) of the holder.

9. The fitting according to claim 8, wherein a section (4) of the yoke (2) bears against the beveled end (10) of the holder, and wherein said section bears against said side (10b) of the holder with the shorter extent along the longitudinal axis (X) when the yoke is located in said first position.

10. The fitting according to any one of the preceding claims, wherein the holder (6) extends along a longitudinal axis (X), wherein the yoke (2) has a first part (3a) secured in the holder and a second part (3b) which extends substantially parallel to the longitudinal axis (X), and wherein the second part is located at a distance from the longitudinal axis.

11. The fitting according to claim 10, wherein the second part (3b) of the yoke is located at a distance of 5-12 centimeters, preferably 5-10 centimeters, and more preferably 6-9 centimeters, from the longitudinal axis (X).

12. A chair (20) for hanging on a table, comprising two fittings (1) according to any one of claims 1-10, the fittings being arranged at opposite side edges of the chair.

13. The chair according to claim 12, wherein the two fittings are secured to the underside of the seat (21) of the chair.
